(19) United States
(12) Patent Application Publication
(10) Pub. No.: US 2017/0040108 A1
(43) Pub. Date: Feb. 9, 2017

(54) CAPACITOR

(71) Applicant: Murata Manufacturing Co., Ltd., Nagaokakyo-shi (JP)

(72) Inventors: Hiromasa Saeki, Nagaokakyo-shi (JP); Naoki lwaji, Nagaokakyo-shi (JP)

(21) Appl. No.: 15/223,290

(22) Filed: Jul. 29, 2016

(30) Foreign Application Priority Data
Aug. 6, 2015 (JP) 2015-156253

(51) Int. Cl. H01G 4/008; H01G 4/30; H01G 4/10

(52) U.S. Cl. CPC H01G 4/008; H01G 4/10; H01G 4/306

(57) ABSTRACT

A capacitor that includes a conductive porous base material; an electrode layer; a dielectric layer between the conductive porous base material and the electrode layer; and an extended electrode on the electrode layer, where the electrode layer has a chlorine content of 2.0 at % or less.

### CROSS REFERENCE TO RELATED APPLICATIONS

The present application claims priority to Japanese Patent Application No. 2015-156253, filed Aug. 6, 2015, the entire contents of which is incorporated herein by reference.

### BACKGROUND OF THE INVENTION

Field of the Invention

The present invention relates to a capacitor.

Description of the Related Art

In recent years, with higher-density mounting of electronic devices, capacitors with higher electrostatic capacitance have been required. As such a capacitor, for example, Nanotechnology 26 (2015) 064002 discloses therein a capacitor that has an Al₂O₃ layer as a dielectric layer and a TiN layer as an upper electrode layer formed on a porous body composed of a carbon nanotube with the use of an atomic layer deposition method (ALD method: Atomic Layer Deposition).

### SUMMARY OF THE INVENTION

In Nanotechnology 26 (2015) 064002, the TiN layer as an upper electrode layer is formed by the ALD method with the use of a TiCl₄ gas and a NH₃ gas. There is a need to form an extended electrode for forming a MIM (metal-insulator-metal) capacitor structure on a three-dimensional microstructure such as a porous body. While the extended electrode is mainly formed by plating, the plating solution does not reach an insulating layer located closer to the base material than the TiN layer, thus causing no breakdown or corrosion of the insulating layer. It is because TiN originally has high chemical resistance and sufficient resistance against the plating solution. However, the present inventors have found that an insulating layer may be broken in the case of forming a MIM capacitor structure on a porous body, and then forming an extended electrode by plating. This suggests the possibility that some sort of cause turns an upper electrode layer into a defective layer.

An object of the present invention is to provide a highly reliable capacitor which has an insulating layer unlikely to be adversely affected even when an upper electrode layer is subjected to plating.

The present inventors have found out, as a result of earnestly carrying out studies to solve the above problem, the problem is caused by the presence of chlorine atoms above a certain level in the upper electrode layer. Further, the present inventors have found that the chlorine concentration of 2.0 at % or less and/or the aluminum content of 2.0 at % or more in the upper electrode layer can provide an upper electrode layer which has excellent plating solution resistance, and provide a highly reliable capacitor without breaking the insulating layer, even when plating is applied.

According to a first aspect of the present invention, a capacitor is provided which includes a conductive porous base material; an electrode layer; a dielectric layer between the conductive porous base material and the electrode layer; and an extended electrode on the electrode layer,

where the electrode layer has a chlorine content of 2.0 at % or less.

According to a second aspect of the present invention, a capacitor is provided which includes a conductive porous base material; an electrode layer; a dielectric layer between the conductive porous base material and the electrode layer; and an extended electrode on the electrode layer,

where the electrode layer has an aluminum content of 2.0 at % or more.

According to the present invention, the chlorine concentration of 2.0 at % or less and/or the aluminum content of 2.0 at % or more in the electrode layer can prevent adverse effects of plating on the dielectric layer. As a result, a highly reliable capacitor can be provided.

### BRIEF DESCRIPTION OF THE DRAWINGS

FIG. 1 is a schematic cross-sectional view of a capacitor 1 according to an embodiment of the present invention;

FIG. 2 is a diagram schematically illustrating a layered structure in the capacitor 1; and

FIGS. 3A to 3D are diagrams for explaining a method for calculating the expanded surface ratio of a porous part.

### DETAILED DESCRIPTION OF THE INVENTION

A capacitor according to the present invention will be described in detail below with reference to the drawings. However, the capacitor according to the present embodiment and the shapes and arrangement of respective constructional elements are not limited to the examples shown in the figures.

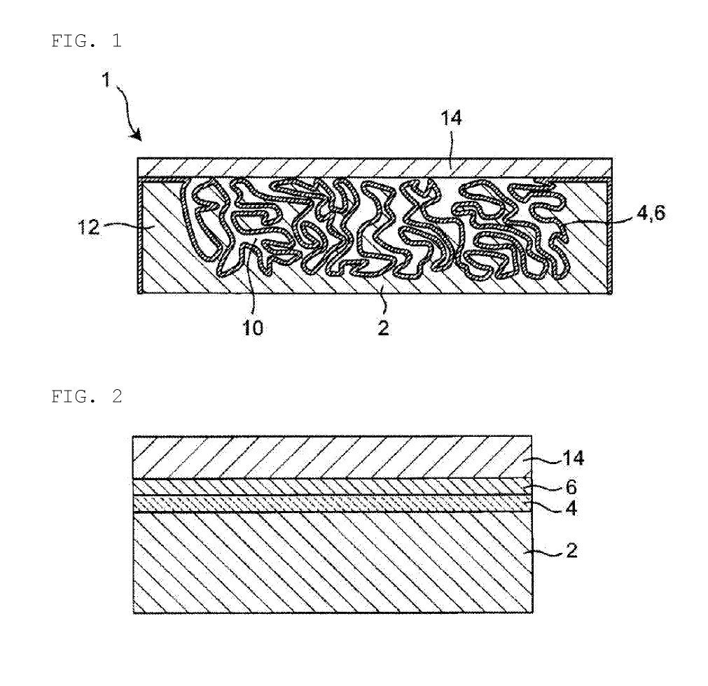

FIG. 1 shows a schematic cross-sectional view of a capacitor 1 according to the present embodiment, and FIG. 2 schematically shows the layered structure (that is, the layered structure of a conductive porous base material 2, a dielectric layer 4, and an upper electrode layer 6) of the capacitor 1. The capacitor 1 according to the present embodiment has a substantially cuboid shape, and as shown in FIGS. 1 and 2, schematically has the conductive porous base material 2 including a porous part 10 and a low-porosity part 12, the dielectric layer 4 formed thereon, the upper electrode layer 6 formed on the dielectric layer 4, and an extended electrode 14 formed thereon to be electrically connected to the upper electrode layer 6. The conductive porous base material 2 can function as an electrode, and is opposed to the upper electrode layer 6 with the dielectric layer 4 interposed therebetween. Charges can be accumulated in the dielectric layer 4 by applying a voltage to the conductive porous base material 2 and the upper electrode layer 6.

The conductive porous base material 2 has a porous part 10 including a large number of pores. The porosity in the porous part 10 can be preferably 20% or more, more preferably 30% or more, further preferably 50% or more, and yet further preferably 60% or more. Increasing the porosity can further increase the capacitance. In addition, from the perspective of increasing the mechanical strength, the porosity of the porous part 10 can be preferably 90% or less, and more preferably 80% or less.

The term “porosity” in this specification refers to the proportion of voids in the porous part. It is to be noted that while the dielectric layer, the upper electrode layer, and the like can be present in pores of the porous part, the porosity in this specification means the porosity in the absence of the dielectric layer, the upper electrode layer, and the like, that is, the porosity in consideration of only the conductive porous base material. The porosity can be measured in the following way.

A sample of the porous part for TEM (Transmission Electron Microscope) observation is prepared by a FIB (Focused Ion Beam) micro-sampling method. A region of approximately 3 μm×3 μm in a cross section of the sample is subjected to measurement by STEM (Scanning Transmission Electron Microscopy)—EDS (Energy Dispersive X-ray Spectrometry) mapping analysis. The proportion of the area without the base material is regarded as the porosity in the visual field of the mapping measurement. This measurement is made at any three locations, and the average value for the measurement values is regarded as a porosity.

The porous part 10 is not particularly limited, but preferably has an expanded surface ratio of 30 times or more and 10,000 times or less, more preferably 50 times or more and 5,000 times or less, for example, 200 times or more and 600 times or less. In this regard, the expanded surface ratio refers to the ratio of the surface area per unit projected area. The surface area per unit projected area can be obtained from the amount of nitrogen adsorption at a liquid nitrogen temperature with the use of a BET specific surface area measurement system.

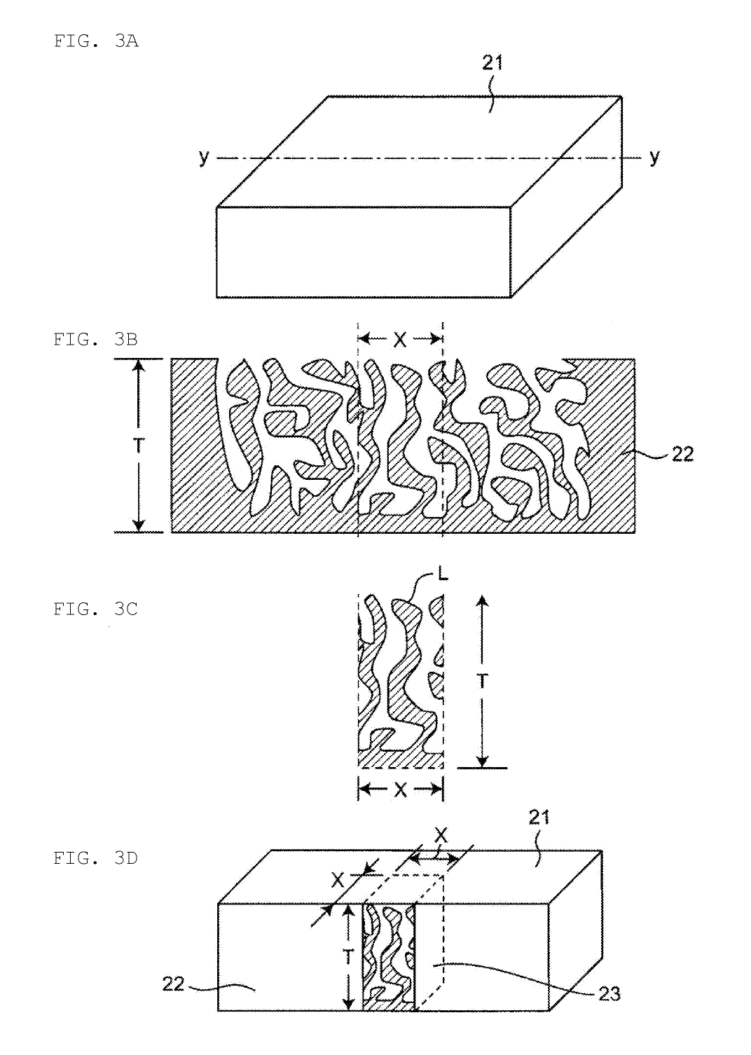

In addition, the expanded surface ratio can be also obtained by the following method. A STEM (scanning transmission electron microscope) image of a cross section of the sample (a cross section obtained by cutting in the thickness direction; see FIGS. 3A and 3B) is taken over the entire area in width X and thickness (height) directions (multiple images may be connected when it is not possible to take the image at a time). Measured is the total path length L of the pore surface (the total length of the pore surface) at the obtained cross section of the width X×the height T (see FIG. 3C). In this regard, the total path length of the pore surface is denoted by LX in the square prism (see FIG. 3D) with the cross section of the width X×the height T as a side surface and the porous base material surface as a bottom. In addition, the area of the base of the square prism is referred to as X².

Accordingly, the expanded surface ratio can be obtained from LX/X²=L/X.

The conductive porous base material 2 has the low-porosity part 12. While the low-porosity part 12 is illustrated on either side of the conductive porous base material 2 in FIG. 1, the low-porosity part 12 is present so as to surround the porous part 10. More specifically, the low-porosity part is also present in front of and behind the drawing. The low-porosity part 12 is a region that is lower in porosity than the porous part 10. It is to be noted that there is no need for the low-porosity part 12 to have pores.

The low-porosity part 12 contributes to improvement of mechanical strength of the capacitor. The porosity of the low-porosity part 12 is preferably 60% or less of the porosity of the porous part 10, and more preferably 50% or less of the porosity of the porous part 10, from the perspective of increasing the mechanical strength. For example, the porosity of the low-porosity part 12 is preferably 20% or less, and more preferably 10% or less. In addition, the low-porosity part 12 may have a porosity of 0%.

It is to be noted the conductive porous base material 2 according to the present embodiment has the low-porosity part 12, but the part is not an essential element. Further, even in the case of providing the low-porosity part 12, there is no particular limitation in terms of location, the number of parts located, size, shape, and the like.

The material and composition of the conductive porous base material 2 are not limited as long as the porous part 10 has a conductive surface. For example, the conductive porous base material 2 may be a conductive metallic porous base material formed from a conductive metal, or a porous base material including a conductive layer formed on a surface of a porous part of a non-conductive porous material, such as a porous silica material, a porous carbon material, or a porous ceramic sintered body.

In a preferred embodiment, the conductive porous base material 2 is a conductive metallic porous base material. Examples of the metal constituting the conductive metallic porous base material include, for example, metals such as aluminum, tantalum, nickel, copper, titanium, niobium, and iron, and alloys such as stainless steel and duralumin. Preferably, the conductive porous base material 2 is an aluminum porous base material.

The conductive porous base material 2 has the porous part only at one principal surface in the present embodiment, but the present invention is not limited thereto. More specifically, the porous part may be present at two principal surfaces. In addition, the porous part is not particularly limited in terms of location, the number of parts located, size, shape, and the like.

In the capacitor 1 according to the present embodiment, the dielectric layer 4 is formed on the conductive porous base material 2.

The material that forms the dielectric layer 4 is not particularly limited as long as the material has an insulating property, but preferably, examples thereof include metal oxides such as AlOₓ (for example, Al₂O₃), SiOₓ (for example, SiO₂), AlTiOₓ, SiTiOₓ, HfOₓ, TaOₓ, ZrOₓ, HfSiOₓ, ZrSiOₓ, TiZrOₓ, TiZrWOₓ, TiOₓ, SrTiOₓ, PbTiOₓ, BaTiOₓ, BaSrTiOₓ, BaCaTiOₓ, and SiAlOₓ; metal nitrides such as AlNₓ, SiNₓ, and AlScNₓ; or metal oxynitrides such as AlOₓN_{y}, SiOₓN_{y}, HfSiOₓN_{y}, and SiCₓO_{y}N_{z}; AlOₓ, SiOₓ, SiOₓN_{y}, and HfSiOₓ are preferred, and AlOₓ (representatively, Al₂O₃) is more preferred. It is to be noted that the formulas mentioned above are merely intended to represent the constitutions of the materials, but not intended to limit the compositions. More specifically, the x, y, and z attached to O and N may have any value larger than 0, and the respective elements including the metal elements may have any presence proportion.

The thickness of the dielectric layer 4 is not particularly limited, but for example, preferably 5 nm or more and 100 nm or less, and more preferably 10 nm or more and 50 nm or less. The adjustment of the thickness of the dielectric layer to 5 nm or more can enhance the insulating property, thereby making it possible to further reduce the leakage current. In addition, the adjustment of the thickness of the dielectric layer to 100 nm or less makes it possible to achieve higher electrostatic capacitance.

The dielectric layer is preferably formed by a gas phase method, for example, a vacuum deposition method, a chemical vapor deposition (CVD: Chemical Vapor Deposition) method, a sputtering method, an atomic layer deposition (ALD: Atomic Layer Deposition) method, a pulsed laser deposition (PLD: Pulsed Laser Deposition) method, or the like. Because a more homogeneous and denser film can be formed even in fine pores of the porous member, the CVD method or the ALD method is more preferred, and the ALD method is particularly preferred.

In the capacitor 1 according to the present embodiment, the upper electrode layer 6 is formed on the dielectric layer 4.

The material constituting the upper electrode layer 6 is not particularly limited as long as the material is conductive, but examples thereof include, Ni, Cu, Al, W, Ti, Ag, Au, Pt, Zn, Sn, Pb, Fe, Cr, Mo, Ru, Pd, and Ta and alloys thereof, e.g., CuNi, AuNi, AuSn, and metal nitrides and metal oxynitrides such as TiN, TiAlN, TiON, TiAlON, and TaN, conductive polymers (for example, PEDOT (poly(3,4-ethylenedioxythiophene)), polypyrrole, polyaniline), and TiN or TiAlN are preferred.

The thickness of the upper electrode layer 6 is not particularly limited, but for example, is preferably 3 nm or more, and more preferably 10 nm or more. The adjustment of the thickness of the upper electrode layer to 3 nm or more can reduce the resistance of the upper electrode layer itself.

In an embodiment, the upper electrode layer 6 contains chlorine atoms. The chlorine content in the upper electrode layer 6 is 2.0 at % or less, and can preferably fall within the range of 1.8 at % or less, more preferably 1.5 at % or less, and further preferably 1.0 at % or less. The reduction in the chlorine content in the upper electrode layer improves the plating resistance of the upper electrode layer.

In another embodiment, the upper electrode layer 6 contains aluminum atoms. The aluminum content in the upper electrode layer 6 is 2.0 at % or more, and can be preferably 3.0 at % or more.

The aluminum content of 2.0 at % or more improves the plating resistance of the upper electrode layer. In addition, the chlorine concentration in the upper electrode layer is lowered. On the other hand, the upper limit of the aluminum content is preferably 20 at % or less, more preferably 12 at % or less, further preferably 10 at % or less, and yet further preferably 6.0 at % or less, and, for example, can be 5.6 at % or less. The aluminum content of 20 at % or less can enhance the conductivity of the upper electrode layer.

The upper electrode layer 6 can be formed by a method that can coat the dielectric layer 4, for example, a method such as an ALD method, a chemical vapor deposition (CVD: Chemical Vapor Deposition) method, plating, bias sputtering, a Sol-Gel method, and conductive polymer filling. Preferably, the upper electrode layer is formed by the ALD method. The use of the ALD method can increase the capacitance.

In an embodiment, another electrode layer may be formed in a way that the upper electrode layer is formed by the ALD method on the dielectric layer 4, and pores are filled thereon by another approach with a conductive substance, preferably a substance that is lower in electrical resistance. This configuration can achieve a higher capacitance density and a lower equivalent series resistance (ESR: Equivalent Series Resistance) effectively. In another embodiment, pores of the porous part may be filled with the same material as the conductive film formed by the ALD method.

In a preferred embodiment, the upper electrode layer is a TiN layer formed by the ALD method with the use of, as reaction gases, a TiCl₄ (titanium tetrachloride) gas and a NH₃ (ammonia) gas.

In another preferred embodiment, the upper electrode layer is a TiAlN layer formed by the ALD method with the use of, as reaction gases, a TiCl₄ (titanium tetrachloride) gas, an Al(CH₃)₃ (trimethyl aluminum) gas, and a NH₃ (ammonia) gas.

In a preferred embodiment, the temperature in the formation of the upper electrode layer by the ALD method can be 325° C. or higher, preferably 350° C. or higher, and more preferably 380° C. or higher. The formation of the upper electrode layer at such a temperature can reduce the chlorine concentration in the upper electrode layer. The upper limit of the temperature in the formation of the upper electrode layer by the ALD method is not particularly limited, but can be preferably 600° C. or lower, and more preferably 500° C. or lower. The ALD method at a temperature of 600° C. or lower can suppress adverse effects on the other members, for example, the base material (e.g., aluminum porous base material).

In the capacitor 1 according to the present embodiment, the extended electrode 14 is formed on the upper electrode layer 6.

The material constituting the extended electrode 14 is not particularly limited, but examples thereof include, for example, metals such as Au, Pb, Ag, Sn, Ni, and Cu, and alloys, as well as conductive polymers.

The method for forming the extended electrode 14 is not particularly limited, but for example, a CVD method, electrolytic plating, electroless plating, vapor deposition, sputtering, baking of a conductive paste, and the like can be used, and electrolytic plating or electroless plating is preferred.

The capacitor according to the present invention can prevent the dielectric layer from being degraded by the plating solution without the plating solution reaching the dielectric layer, even when the extended electrode is formed by plating. This is because the upper electrode layer 6 has high plating resistance. Therefore, the capacitor according to the present invention can have high reliability.

While the capacitor according to the present embodiment has been described above with reference to the capacitor 1 according to the embodiment as mentioned above, the present invention is not limited thereto, and various modifications can be made thereto.

For example, the capacitor according to the present invention has only to have the dielectric layer between the porous part and the upper electrode layer, and may have a layer other than the layers presented in the embodiment described above.

In an embodiment, another layer may be present between the base material and the dielectric layer.

In another embodiment, another layer may be present between the dielectric layer and the upper electrode layer.

In another embodiment, another layer may be present between the upper electrode layer and the extended electrode.

In another embodiment, a dielectric layer and an electrode layer may be further formed on the upper electrode layer.

### EXAMPLES

### Example 1

Prepared was a commercial aluminum etching foil with an expanded surface ratio of 250 times. For this foil, a dielectric layer of Al₂O₃ of 10 nm in thickness was formed by an ALD method. Specifically, a step of alternately supplying a trimethyl aluminum (Al(CH₃)₃) gas and a water vapor (H₂O) gas to the foil was repeated a predetermined number of times, thereby forming an Al₂O₃ layer on the foil. It is to be noted that the temperature in the deposition of the Al₂O₃ layer was adjusted to 250° C.

Next, a TiN layer was formed as an upper electrode layer by an ALD method. Specifically, a step of alternately supplying a titanium tetrachloride (TiCl₄) gas and an ammonia (NH₃) gas was repeated a predetermined number of times, thereby forming a TiN layer on the Al₂O₃ layer. Further, the temperature in the deposition of the TiN layer was varied to 300° C., 325° C., 350° C., 375° C., and 400°, thereby preparing five types of samples.

These samples were subjected to FIB processing with the use of a focused ion beam system (SM13050SE from SII NanoTechnology Inc.), thereby exposing cross sections of the TiN layers deposited. The TiN cross sections were subjected to composition analysis by X-ray photoelectron spectrometry (XPS), thereby figuring out the concentrations (at %) of chlorine remaining in the TiN films. The remaining amount of chlorine was calculated by applying the measurement to ten samples and figuring out the average value for the samples. The results are shown in Table 1.

TABLE 1

| Temperature at Deposition of | The Amount of Remaining |
|---|---|
| TiN Layer (° C.) | Chlorine (at %) |
| 400 | 0.3 |
| 375 | 1.0 |
| 350 | 1.7 |
| 325 | 2.0 |
| 300 | 2.2 |

Next, the respective samples prepared in the way described above were immersed for 60 minutes at a bath temperature of 30° C. in an electroless Cu plating bath (using a commercial Rochelle salt-based Cu plating solution) to form extended electrodes of Cu plated layers of 2 μm in thickness on the upper electrode layers. The pH was adjusted to 12.0, 12.6, and 12.8 by adjusting the amount of sodium hydroxide. In the way mentioned above, three types of capacitor samples were prepared for each of the samples with the respective amounts of remaining chlorine.

Next, each of the capacitor samples prepared in the way mentioned above was evaluated for the withstand voltage of the Al₂O₃ film, thereby determining whether degradation was caused or not. Specifically, a direct-current voltage of DC 10 V was applied for 1 minute to ten pieces for each sample, thereby evaluating whether short circuit was caused or not. The sample even with one of the ten short-circuited was regarded as “degraded”. The results are shown in Table 2.

TABLE 2

| | | Residual Chlorine Concentration in TiN, | | | | |
|---|---|---|---|---|---|---|
| | | measured by XPS (at %) | | | | |
| | | 0.3 | 1.0 | 1.7 | 2.0 | 2.2 |
| pH of | 12.0 | Not | Not | Not | Not | Degraded |
| Plat- | | degraded | degraded | degraded | degraded | |
| ing | 12.6 | Not | Not | Not | Not | Degraded |
| Solu- | | degraded | degraded | degraded | degraded | |
| tion | 12.8 | Not | Not | Not | Not | Degraded |
| | | degraded | degraded | degraded | degraded | |

With the residual chlorine concentration in the TiN in the range of 2.0% or less, the insulation property of the dielectric layer was not found to be degraded even after the plating step. On the other hand, in the case of the sample with the residual chlorine concentration of 2.2%, the dielectric layer was found to be degraded depending on the plating. This is believed to be because the chemical resistance against the plating solution for the TiN layer is decreased when the residual chlorine concentration in the TiN is high.

### Example 2

In place of the TiN layer in Example 1, a TiAlN layer was formed. However, the temperature for the deposition was adjusted to 300° C., and the pH of the plating bath was adjusted to 12.0. The other operations were all carried out in the same manner as in Example 1. The TiAlN layer was formed by repeating, a predetermined number of times, a step of alternately supplying a titanium tetrachloride (TiCl₄) gas, a trimethyl aluminum (Al(CH₃)₃) gas, and an ammonia (NH₃) gas. The thickness was adjusted to 15 nm, as with the TiN layer in Example 1. In addition, the concentration of Al in the TiAlN layer was changed by varying the time period of supplying the trimethyl aluminum (Al(CH₃)₃) gas.

For the samples prepared as mentioned above, the residual chlorine amount (at %) and Al amount (at %) contained in the TiAlN layer were measured in the same way as in Example 1. The result is shown in Table 3 below.

Next, in the same way as in Example 1, extended electrodes were formed by Cu electroless plating (the pH was adjusted to 12.6), thereby preparing capacitors of the same structure as Example 1. In addition, the capacitors were evaluated in the same manner as in Example 1, thereby evaluating whether the dielectric layers were degraded or not. The results are shown in Table 3.

TABLE 3

| | |
|---|---|
| Cl and Al Contents | |
| in TiAlN Layer | |
| (at %) | Degradation of |

| Cl Content | Al Content | Dielectric Layer |
|---|---|---|
| 2.2 | 0 | Degraded |
| 1.0 | 2.0 | Not degraded |
| Lower detection | 5.6 | Not degraded |
| limit or less* | | |
| Lower detection | 10.4 | Not degraded |
| limit or less | | |
| Lower detection | 15.1 | Not degraded |
| limit or less | | |

*lower detection limit or lower: 0.3 at % or less

The TiAlN layer containing Al of 2.0 at % or more resulted in the residual Cl amount of 2.0 at % or less in the TiAlN layer, thereby making it possible to suppress degradation of the dielectric layer as in Example 1. The following is conceivable as reasons therefor while the present invention is not bound by any theory. (i) The adoption of TiAlN improved the chemical resistance. (ii) The vaporization of Al combined with chlorine in the formation of TiAlN reduced the chlorine concentration in the film. (iii) The adoption of TiAlN made TiN, originally for columnar growth, amorphous, thereby eliminating grain boundaries.

The capacitor according to the present invention is preferably used for various electronic devices because of its remarkable stability and high reliability.

What is claimed is:

1. A capacitor comprising:
a conductive porous base material;
an electrode layer;
a dielectric layer between the conductive porous base material and the electrode layer; and
an extended electrode on the electrode layer,
wherein the electrode layer has a chlorine content of 2.0 at % or less.

2. The capacitor according to claim 1, wherein the chlorine content in the electrode layer is 1.0 at % or less.

3. The capacitor according to claim 1, wherein the electrode layer contains 2.0 at % or more of aluminum.

4. The capacitor according to claim 1, wherein the electrode layer contains 2.0 to 20 at % of aluminum.

5. The capacitor according to claim 1, wherein the electrode layer is an atomic deposition layer.

6. The capacitor according to claim 1, wherein the electrode layer is a TiN or TiAlN layer.

7. The capacitor according to claim 1, wherein the dielectric layer comprises Al₂O₃.

8. The capacitor according to claim 1, wherein the conductive porous base material has a porosity of 20% or more.

9. The capacitor according to claim 1, wherein the conductive porous base material has a porosity of 60% or more.

10. The capacitor according to claim 1, wherein the conductive porous base material has a porosity of 20% to 90%.

11. The capacitor according to claim 1, wherein the conductive porous base material has a porosity of 60% to 80%.

12. The capacitor according to claim 1, wherein the conductive porous base material includes a first porosity part and a second porosity part, the first porosity part having a porosity lower than that of the second porosity part.

13. The capacitor according to claim 1, wherein the porosity of the first porosity part is 60% or less of that of the second porosity part.

14. A capacitor comprising:
a conductive porous base material;
an electrode layer;
a dielectric layer between the conductive porous base material and the electrode layer; and
an extended electrode on the electrode layer,
wherein the electrode layer has an aluminum content of 2.0 at % or more.

15. The capacitor according to claim 14, wherein the electrode layer contains 2.0 to 20 at % of aluminum.

16. The capacitor according to claim 14, wherein the electrode layer is an atomic deposition layer.

17. The capacitor according to claim 14, wherein the electrode layer is a TiN or TiAlN layer.

18. The capacitor according to claim 14, wherein the dielectric layer comprises Al₂O₃.

19. The capacitor according to claim 14, wherein the conductive porous base material has a porosity of 20% or more.
